(19) United States
(12) Patent Application Publication
(10) Pub. No.: US 2016/0116912 A1
(43) Pub. Date: Apr. 28, 2016

(54) SYSTEM AND METHOD FOR CONTROLLING UNMANNED VEHICLES

(71) Applicants: Youval Nehmadi, Nili (IL); Alon Konchitsky, Santa Clara, CA (US)

(72) Inventors: Youval Nehmadi, Nili (IL); Alon Konchitsky, Santa Clara, CA (US)

(21) Appl. No.: 14/488,853

(22) Filed: Sep. 17, 2014

(51) Int. Cl. G05D 1/00; G06F 3/0481; G01S 19/13

(52) U.S. Cl. CPC G05D 1/0022; G01S 19/13; G06F 3/0481; H04W 84/042

(57) ABSTRACT

A system for controlling an unmanned vehicle is disclosed to facilitate remote-control operation of the unmanned vehicle from long distances. The system includes at least one ground control communication device having a transceiver configured for operation in a cellular communication network. The system also includes an unmanned vehicle comprising another transceiver configured for operation in the cellular communication network. The unmanned vehicle is further configured to be responsive to communications received via the transceiver from the communication device, wherein the communications received from the communication device includes operation commands. Additionally, the unmanned vehicle is configured to transmit video surveillance data and other monitoring data to the communication device via the cellular network.

### BACKGROUND

### Field of the Invention

Embodiments of the present invention generally relate to a system and method for operating an unmanned vehicle and particularly to a system and method for operating an unmanned vehicle from long distances.

Unmanned vehicles (UVs), including Unmanned vehicles (UVs) are gaining increasing importance in military arena as well as civilian applications, in particular for research purposes. In an unmanned vehicle, no human controller is required on board the vehicle; rather, operations are computer controlled. For example, the UV can be remotely controlled from a control station.

The UVs provide enhanced and economical access to areas where manned operations are unacceptably costly or dangerous. For example, the UVs outfitted with remotely controlled cameras can perform a wide variety of missions, including but not limited to monitoring weather conditions, providing surveillance of particular geographical areas, or for delivering products over distances.

Existing techniques for controlling the UVs suffer from a variety of drawbacks. For example, existing UVs are typically controlled using either direct RF communication or satellite communication. However, these technologies are not efficient enough to control the UVs from long distances. For example, direct RF-based control is limited by its short range and high power requirements. The RF-based control also requires specialized equipment at both the UV and the control station, which is expensive.

Although, controlling the UVs by satellite based control may allow for longer-range communications when compared with direct RF-based control, however, the satellite based control is typically limited by low bandwidth and low data rate limits. Therefore, the satellite based control is not efficient in case of high definition real-time video surveillance and in related applications.

There is thus a need for a system and method to efficiently control the UVs from long distances.

### SUMMARY

Embodiments in accordance with the present invention provide a communication device comprising a user interface for receiving an input from a user. The communication device further includes a command generator configured to generate at least one control command based on the input, wherein the at least one control command is associated with at least one predefined control function of an Unmanned Vehicle (UV). The communication device further includes a transceiver configured to transmit, in real time, at least one cellular communication signal to the UV, wherein the at least one cellular communication signal comprises the at least one control command.

Embodiments in accordance with the present invention further provide an Unmanned Vehicle. The UV includes an image sensor, a Global Positioning System (GPS) tracking unit, and a transceiver for receiving control commands from a communication device and for transmitting surveillance and navigational data captured via the image sensor and the GPS tracking unit to the communication device in real time, wherein the transceiver and the communication device are connected via a cellular network. The UV further includes a control module for controlling the UV based on the control commands received from the communication device and an artificial intelligence module for overriding the received control commands under predefined conditions with predefined control commands.

Embodiments in accordance with the present invention further provide a system for controlling an unmanned vehicle comprising at least one ground control communication device having a transceiver configured for operation in a cellular communication network. The system further comprises an unmanned vehicle including a transceiver configured for operation in the cellular communication network, wherein the UV is responsive to communications from the at least one ground control communication device, including communications received via the transceiver, wherein the communications received via the transceiver comprises at least one control command.

The present invention can provide a number of advantages depending on its particular configuration. First, the present invention can work as a virtual eye for many different applications e.g., virtual tourism, agriculture, entertainment, police/fire control, traffic, border patrol, package delivery, etc. The present invention can further be used for a plurality of civil and military applications that requires video surveillance and product deliveries.

Next, the present invention allows users to control the UVs from any part of the earth, where cellular network is available. This enables civilians to use the UVs for a variety of personal projects with an ease of internet connection and a communication device only. The UVs according to the present invention are designed to be safe enough to override user mistakes and abuses.

These and other advantages will be apparent from the disclosure of the present invention(s) contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates an environment where various embodiments of the present invention are implemented;

FIG. 2 illustrates a block diagram of an Unmanned vehicle that may be controlled from a remote location, in accordance with an embodiment of the present invention;

FIG. 3 illustrates an operating zone for an unmanned vehicle in accordance with an embodiment of the present invention;

FIG. 4 illustrates a block diagram of a communication device for controlling an Unmanned vehicle from a remote location, in accordance with an embodiment of the present invention;

FIGS. 5A and 5B illustrate a user interface of the communication device of FIG. 4, in accordance with an embodiment of the present invention;

FIG. 6 depicts a flowchart of a method for controlling an Unmanned vehicle via a communication device, in accordance with an embodiment of the present invention;

FIGS. 7A and 7B depicts a flowchart of a method for autonomously managing operating modes of an Unmanned vehicle in accordance with an embodiment of the present invention;

FIG. 8 depicts a flowchart of a method for determining a safe operating zone path for an Unmanned vehicle, in accordance with an embodiment of the present invention;

FIG. 9 depicts a flowchart of a method for implementing a safe operating zone only path for an Unmanned vehicle, according to an exemplary embodiment of the present invention; and

FIG. 10 depicts a flowchart of a method for automatic detection and avoidance from an anticipated collision for an unmanned vehicle, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

The phrases used in the present invention such as “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation performed without material human input. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “module” as used herein refers to any known or later developed hardware, software, firmware, artificial intelligence, fuzzy logic, or a combination thereof that is capable of performing the functionality associated with that element.

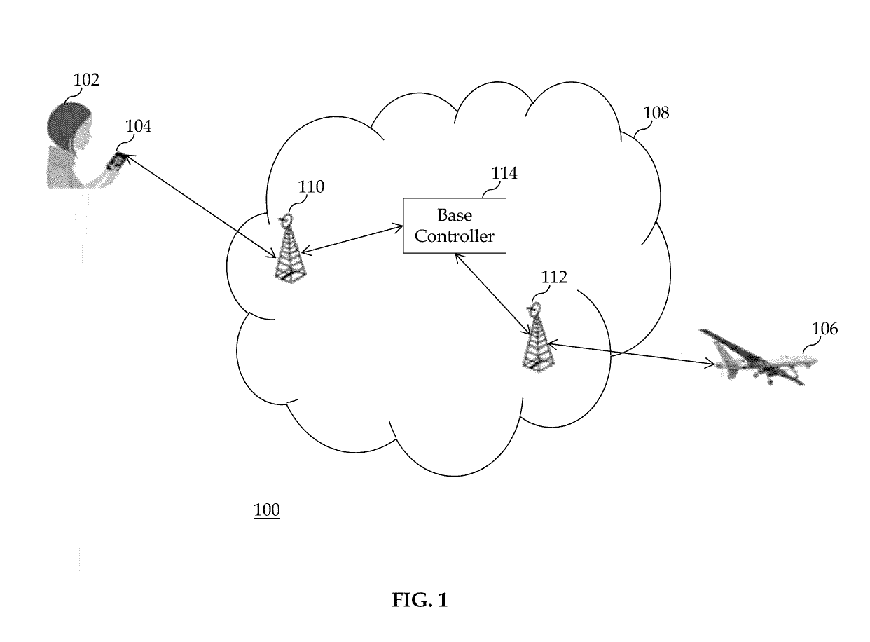

FIG. 1 illustrates an environment 100 where various embodiments of the present invention may be implemented. The environment 100 includes a user 102 using a communication device 104 that is connected to an unmanned vehicle (UV) 106 via a network 108. Present invention is applicable for all unmanned vehicles including, but not limited to Unmanned Aerial Vehicle (UAV), Unmanned Underwater Vehicle (UUV), and Unmanned Ground Vehicle (UGV), that can be controlled remotely. The UV 106 may refer to a device that can move and can be controlled remotely by user(s). The network 108 may include, but is not restricted to, a communication network such as the Internet, a cellular network, a wireless network, radio network, and so forth. In a preferred embodiment of the present invention, the network 108 is a high bandwidth cellular network that is capable of transferring high definition 3D video data in real time.

The Network 108 is schematic of a typical cellular network. Examples of various types of cellular networks may include, but are not limited to, GSM, CDMA, 3G, 4G, etc. having similar architectures. Architecture of a typical cellular network includes various components such as a Mobile Switching Centre (MSC), a Base Station Controller (BSC), a Base Transceiver Station (BTS) and cell phones. Similarly, as shown in the FIG. 1 of the present invention, the network 108 includes two base transceiver stations 110 and 112 that are connected to a base controller 114. In general, the base transceiver stations are responsible for connecting plurality of cell phones (that are available within their range) with a base controller (e.g., BSC or MSC) of their network. The base controller is further responsible for connecting a cellular device with another cellular device that is geographically at a different place.

A typical communication link between a requesting cellular device and a destined cellular device is illustrated in FIG. 1 of the present invention, where the communication device 104 is connected to the UV 106 via the cellular network 108, wherein the communication device 104 is connected to its nearest BTS 110 and the UV 106 is connected to its nearest BTS 112. It will be appreciated by a person skilled in the art that the FIG. 1 is a basic illustration of a typical cellular network for explanation purpose only, wherein in real environments the illustration may be very different and the cellular devices may be connected via a plurality of Base transceiver stations and base controllers.

In an exemplary embodiment of the present invention, FIG. 1 illustrates a system 100 for remotely controlling a UV 106 with a communication device 104, wherein the communication device 104 and the UV 106 are connected via a cellular network (e.g., the network 108). In a preferred embodiment of the present invention, the communication device 104 is a mobile device or an equivalent state of the art device that is able to receive inputs from a user, connect wirelessly to the remote UV 106, receive and display high definition or 3D video/graphics, and is able to play received audio data etc.

In a preferred embodiment of the present invention, the user 102 (who is remotely controlling the UV 106) is not required to be a professional in operating the UV 106. The user 102 may remotely operate the UV 106 from any geographic location, e.g., from his/her home or office etc. by using a simple navigation user interface on his/her communication device 104, for example, a Smartphone. In an embodiment of the present invention, the UV 106 may be present at a different geographical location in respect to the user 102 (e.g., the UV 106 may even be present in a different country).

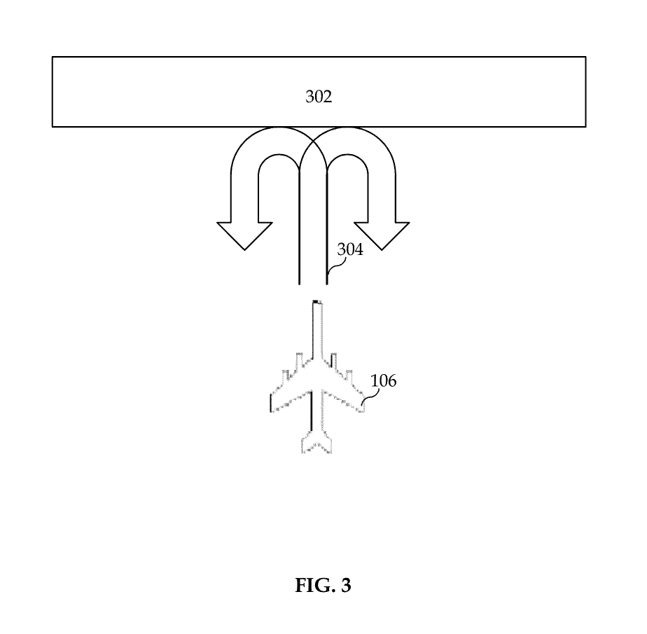

Further, based on the real time images/video captured from the image sensors installed on the UV 106, the user 102 may operate the UV 106 from remote locations. The image sensors (e.g., cameras) installed on the UV 106 may be installed to transmit video surveillance data to the communication device 104 of the user 102 in real time. In an exemplary embodiment of the present invention, the user 102 may use the Internet to connect his/her Smartphone to control panel of the UV 106 for controlling operations of the UV 106. More details corresponding to the operations of the UV 106 are provided below in conjunction with FIG. 3 of the present invention.

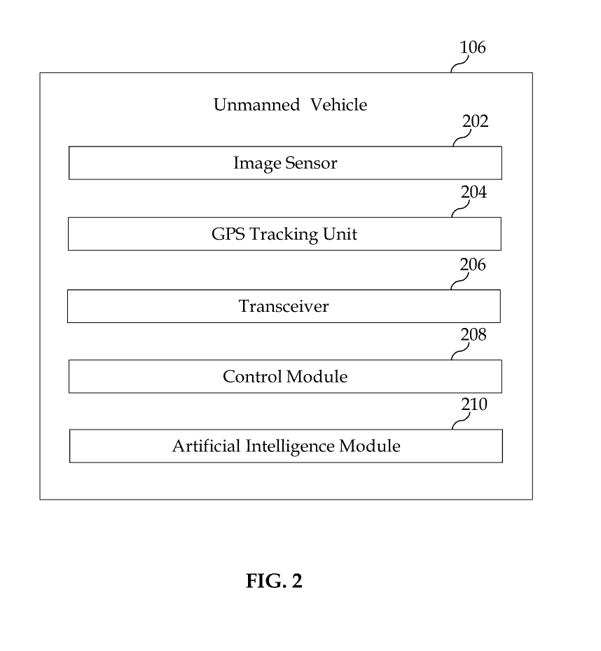

FIG. 2 illustrates a block diagram of an Unmanned Vehicle (UV), such as the UV 106, that may be controlled from a remote location, in accordance with an embodiment of the present invention. The UV 106 includes an image sensor 202, a Global Positioning System tracking unit 204 (hereinafter referred to as ‘GPS’), a transceiver 206, a control module 208, and an artificial intelligence module 210. Though not shown, the UV 106 may include other components as well such as, but are not limited to, a temperature module, a humidity module, a pressure module, a Laser module, and an Inertial Measurement Unit (IMU) (not shown).

It will be appreciated by a person skilled in the art that the FIG. 2 is a basic illustration of a typical UV 106, wherein an actual UV 106 may include additional components than are illustrated. The illustration of the UV 106 in FIG. 2 is for explanation purpose only and does not limit the components required for actual functionality of the remote controlled UV 106. In contrast, the components illustrated in the FIG. 2 of the present invention plays major role in functioning as required in implementation of the present invention. However, the components displayed in the FIG. 2 may be dependent on certain other components that are not illustrated but are required for practical implementation of the present invention.

In an exemplary embodiment of the present invention, the UV 106 may be designed to work in diverse urban and rural locations. Further, the UV 106 may be designed to have autonomous (e.g., the autonomous mode) and semi-autonomous operating mode (e.g., the remote-operation mode) capabilities. Under the semi-autonomous operating mode, the user 102 may have the authority to control the operations of the UV 106. However, the UV 106 may continuously monitor its surroundings to create a safe operating zone. Further, if the UV 106 operating under the semi-autonomous mode determines any violation of the safe operating zone then the UV 106 may overtake its operation control from the user 102 and continue operating within the determined safe operating zone only. The UV 106 may be connected over the Internet, cellular networks, and Radio Links allowing it to be controlled from remote locations (such as home or office) using state of art input devices e.g., a mouse, a keyboard, or a touch screen of a Smartphone.

Further, the UV 106 may be configured to collect data (images, 2D/3D videos, audios etc.) and may be configured to send the data via a cellular network 108 (or the Internet) to the user 102 enabling 3D visualization of the scene, which is captured by the image sensors 202 installed on the UV 106. The communication channel between the UV 106 and the communication device 104 may be built to support information security during data transfer. In an embodiment of the present invention, the UV 106 may be designed to function as a virtual eye for different applications such as virtual tourism, agriculture, entertainment, police/fire control, traffic, border patrol, and make deliveries. As the virtual eye, the UV 106 may be configured to take measurements of the surroundings with high precision. For example, the UV 106 may be able to measure distances to and/or dimensions of nearby buildings, trees or other structures with a high precision.

In a preferred embodiment of the present invention, the UV 106 may be configured to navigate autonomously (under autonomous mode) using GPS information, 3D image sensing capacities, and artificial intelligence. The UV 106 may use an integrated sensor for collecting information, such as images and 3D data. In addition, the UV 106 may be installed with certain special task sensors for measuring temperature and humidity and may also be equipped with other components like speakers and microphones.

Further, the UV 106 may be equipped with an artificial cognitive system for special purposes like take-off, flying, operating, and landing in different type of terrains. The artificial cognitive system may also be used to avoid collisions with other UVs and with other operating, moving or stationary objects. Additionally, the UV 106 may be designed to operate in a safe protected mode. In the safe protected mode, the UV 106 may use an auto pilot function that may be designed to prevent the UV 106 from user mistakes or abuse. For example, if the user 102 tries to crash the UV 106 into a mountain or into another object, the UV 106 may take over the control and may operate only within a predetermined safe operating zone. Further, under the safe protected mode, the UV 106 may keep a safe distance from animals, people, and from other moving or stationary objects.

In an exemplary embodiment of the present invention, the UV 106 may pre-store information corresponding to safe operating zones or may generate or receive the information in real time. In a preferred embodiment of the present invention, the UV 106 may be configured to use various sensors installed on the UV 106 (such as GPS, Laser, or Image sensors) to determine safe operating zones by analyzing its surroundings in real time after every preset time interval. Further, based on information retrieved via the GPS, the UV 106 may be restricted to operate in certain predefined restricted and limited geographical regions.

For example, three types of restricted and limited geographical regions may be predefined for the operation of the UVs. Such regions may include, but are not restricted to, a no-network zone, a restricted height zone, and a restricted zone. Under no-network zones, the user 102 may not be able to control the UV 106. Therefore, prior to entering such type of zone the user 102 must approve and indicate destination location for the UV 106. The UV 106 may then reach to the destination location autonomously by operating under autonomous mode, which may use image sensors, GPS sensors, and artificial intelligence for determining the operating path to the destination location.

Further, during the autonomous mode, the UV 106 may scan its surroundings for identifying moving and non moving obstacles in it way to avoid collision. Based on the scanned surroundings, the UV 106 may determine its speed and direction and may self define a safe operating zone every predetermined interval. In one embodiment, the predetermined interval is around 10 milliseconds. In a preferred embodiment of the present invention, the UV 106 may be restricted to operate in the safe operating zones only despite the fact that the UV 106 is operating under autonomous mode or remote-operation mode.

In an exemplary scenario where the UV 106 flies under control of the user 102 and is restricted to operate under safe operating zones only, then the user 102 may not be able to move the UV 106 outside of the safe operating zone. However, the user 102 can control the UV 106 using the direction controls of the communication device 104 but is allowed to operate within the safe operating zones only. In a preferred embodiment of the present invention, the UV 106 may be configured to take over the control from the user 102 in case the user 102 makes a mistake jeopardizing the UV 106 or in case the UV 106 is likely to collide with another object.

In a preferred embodiment of the present invention, the UV 106 includes an image sensor 202, a GPS tracking unit 204, and a transceiver 206 for receiving control commands from the communication device 104. The transceiver 206 may be configured for transmitting surveillance and navigational data captured via the image sensor 202 and the GPS tracking unit 204 to the communication device 104 in real time. Herein the transceiver 206 and the communication device 104 may be connected via a cellular network 108 or via the Internet. Further, the UV 106 includes a control module 208 for controlling the UV 106 based on control commands received from the communication device 104 via the cellular network 108 using the transceiver 206 of the UV 106.

In addition, the UV 106 includes an artificial intelligence module 210 for overriding the received control commands (via the transceiver 206) under predefined conditions with predefined control commands. In an exemplary embodiment of the present invention, the predefined conditions may include, but are not limited to, an anticipated collision, an entrance into a predefined restricted zone, an entrance into a predefined restricted height zone, or a violation of the safe operating zone. Further, the predefined commands may correspond to a command for switching to autonomous mode, where the UV 106 is configured to operate only under safe operating zones. In addition, the control module 208 may be further configured to detect lag in receiving instructions from the user 102 and may therefore take a decision of switching to the autonomous mode to automatically (without any guidance from the user 102) complete the mission based on pre-defined instructions or mission details.

Further, the artificial intelligence module 210 may be configured to enable the UV 106 to keep a predefined distance from human beings, animals, and other operating, moving or stationary objects for avoiding collision. The artificial intelligence module 210 may further be configured to restrict the UV 106 from entering the predefined restricted zones. The artificial intelligence module 210 may also be configured to enable the UV 106 to navigate at predetermined altitudes only within a predefined restricted height zone. In an additional embodiment of the present invention, the user 102 may use the UV 106 to deliver a package to a destination. Further, the UV 106 may be equipped with special components to communicate to an entity at the destination via a speaker and a microphone. The UV 106 may further be configured to receive voice signature of the entity confirming delivery of a package dropped at the destination. In one embodiment, the entity receiving the package at the destination may be a person and the UV 106 may identify the person by performing face recognition, voice signatures and/or any biometric data.

FIG. 3 illustrates an operating zone for the UV 106 according to an embodiment of the present invention. A region 302 and a region 304 should be free of any obstacle for the UV 106 to operate safely. In other words, any obstacle detected in the regions 302 and 304 is interpreted as an anticipated collision of the UV 106 with the obstacle. If there is any obstacle in the regions 302 and 304, the UV 106 based on a command received from the communication device 104 or automatically in the autonomous mode, determines a new route to avoid the collision.

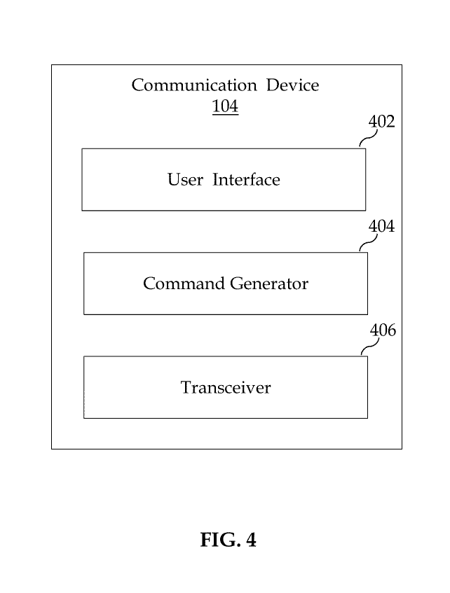

FIG. 4 illustrates a block diagram of the communication device 104, for controlling the UV 106 from a remote location, in accordance with an embodiment of the present invention. The communication device 104 includes a user interface 402, a command generator 404, and a transceiver 406. It will be appreciated by a person skilled in the art that FIG. 4 is a basic illustration of the communication device 104, wherein an actual communication device 104 may include additional components and functionalities. The illustration of the communication device 104 in FIG. 4 is for explanation purpose only and does not limit the components required for actual functionality of the communication device 104 to control the UV 106. In contrast, the components illustrated in FIG. 4 of the present invention plays major role in functioning as required in implementation of the present invention. However, the components displayed in the FIG. 4 may be dependent on certain other components that are not illustrated but are required for practical implementation of the present invention.

The user interface 402 provides a medium to the user 102 of the communication device 104 to communicate control instructions to the UV 106. The user 102 may interact with the user interface 402 through a mouse, a handheld controller (e.g. a joystick, game pad or keyboard arrow keys), or a keyboard. In one embodiment of the present invention, the communication device 104 is a Smartphone and the user 102 interacts with the user interface 402 through touch screen of the Smartphone.

The user interface 402 is therefore configured to receive inputs from the user 102. The user interface 402 is further configured to display, in real time or time in a shift mode, data received from the UV 106. In an embodiment, the user interface 402 receives the real time data via the transceiver 406 of the communication device 104. Further, the data received by the user 102 may include, but is not limited to, graphics, video, audio, UV status information, UV navigation information, etc. In an exemplary embodiment of the present invention, the user interface 402 may display real time video captured via image sensors installed on the UV 106 to help the user 102 remotely control the navigation operation of the UV 106.

In a preferred embodiment of the present invention, the UV 106 is remotely controlled via the communication device 104 under remote-operation mode of the UV 106, wherein the UV 106 and the communication device 104 are connected via a cellular network and the UV 106 remotely receives operation commands from the communication device 104. Further, the user interface 402 may include state of the art input techniques such as using accelerometer, and/or Gyroscope for enabling users to tilt their Smartphone to instruct the UV 106 to turn or tilt in real time.

In one embodiment of the present invention, the UV 106 may operate in an autonomous mode. Under the autonomous mode the UV 106 is configured to self identify its operating route based on the data retrieved by its image sensors and GPS sensors. Further, the autonomous mode of the UV 106 is configured to automatically override the remote-operation mode of the UV 106 under certain predefined conditions.

In an exemplary embodiment of the present invention, the user interface 402 is configured to provide the inputs received from the user 102 to the command generator 404 of the communication device 104. The inputs received from the user 102 may correspond to an instruction from the user 102 for the control operations of the UV 106. The inputs from the user 102 may be received via a touch interface, a tangible button, a gesture input, a sound input via microphone, a graphical input via camera, a motion input captured via an accelerometer, or any known state of art input method. The command generator 404 may therefore be configured to interpret the input instruction received from the user 102 and convert into at least one of a predefined control command that is responsible for controlling at least one operation/function of the UV 106. Such control commands may be transmitted to the UV 106 by the command generator 404 with the help of the transceiver 406.

More specifically, the command generator 404 is responsible for conversion of user instructions into related commands that are executable/understandable by the UV 106. In an embodiment of the present invention, the UV 106 can be controlled using a list of predefined control commands and the command generator 404 is responsible for selecting a suitable command from the list of the predefined commands based on the instructions received from the user 102 via the user interface 402. The selected command(s) are then transmitted by the communication device 404, in real time, to the UV 106 via the transceiver 406. In a preferred embodiment of the present invention, the transceiver 406 is configured to use at least one of the Internet, one or more cellular networks, and one or more radio links for establishing a communication link with the UV 106.

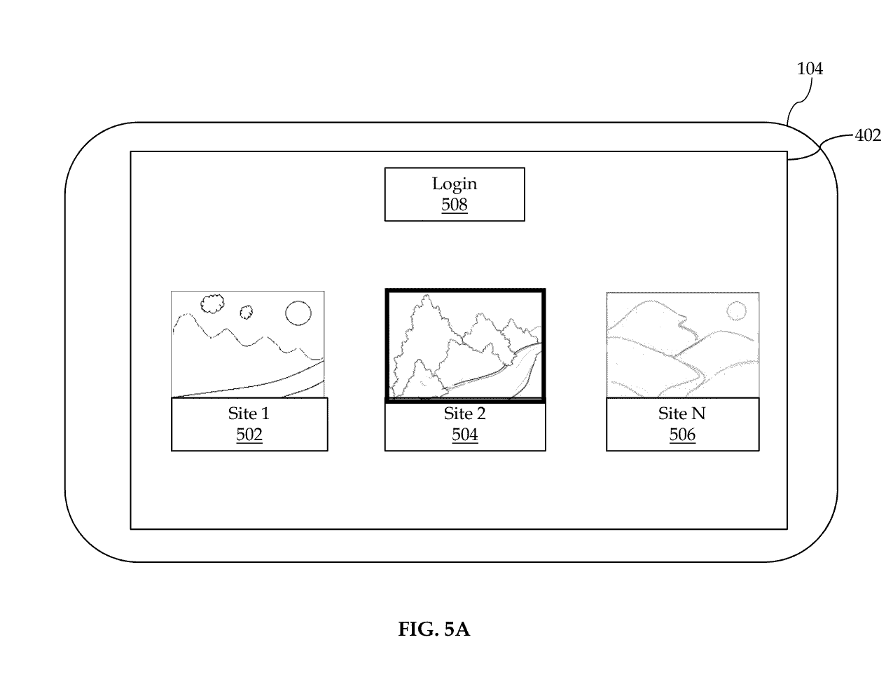

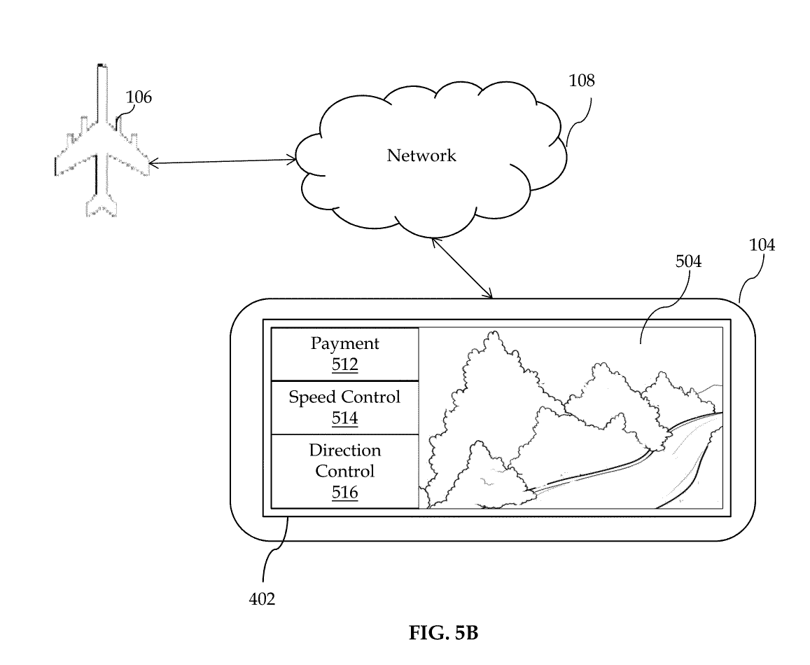

FIGS. 5A and 5B illustrate the user interface 402 of the communication device 104 according to an embodiment of the present invention.

Referring to FIG. 5A, the user interface 402 may include destination selection means. The user 102 may be presented with destination selection options such as Site 1 502, Site 2 504, and Site N 506 from which the user 102 may select a preferred destination for the mission. For example, as shown, the user 102 has selected a Site 2 as the destination. The Site 2 504 may be selected based on the mission requirements and preferences of the user 102. If the user 102 is registered with the services of a service provider, the user 102 may login to his account using a login option 508.

Referring to FIG. 5B, the UV 106 transmits live video, images, data to the communication device 104 during the mission at the selected destination, i.e., Site 2 504. The transmission may be via the cellular network 108. The user 102 may be presented with speed control 514 and direction control 516 for controlling the UV 106. The user 102 may further be presented with a payment option 512 to pay for the services. The payment option 512 may include or conform to well known, developing or new techniques, systems, methods and/or algorithms.

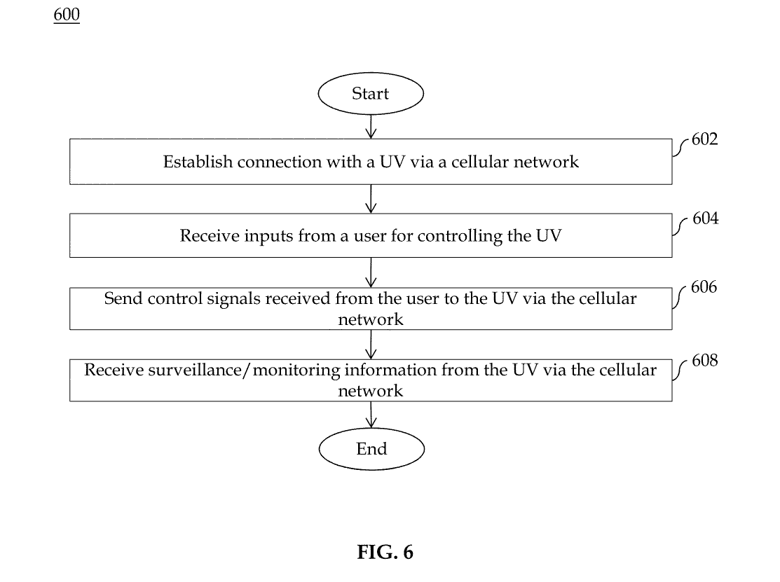

FIG. 6 depicts a flowchart of a method 600 for controlling an Unmanned vehicle (e.g., the UV 106) via a remote terminal (e.g., the communication device 104), according to an exemplary embodiment of the present invention. At step 602 establishes a communication link with the UV 106 via a cellular network, such as the network 108. In a preferred embodiment of the present invention, the communication device 104 establishes a communication link with the UV 106 via a cellular network or the Internet.

At step 604, the communication device 104 receives inputs from the user 102. The user 102 inputs may correspond to control commands for controlling the UV 106 from a different geographical location. In an embodiment of the present invention, the communication device 104 may be a cellular phone, a smart phone, a tablet, or a laptop. In one embodiment of the present invention, the communication device 104 is a Smartphone and the user 102 provides inputs via touch-screen of the Smartphone.

At step 606, the communication device 104 transmits the control commands received from the user 102 to the UV 106 via the cellular network 108 using a transceiver 406 compatible with the cellular network 108. In an embodiment of the present invention, the UV 106 may also be equipped with a similar transceiver 206 for communicating with the communication device 104 via the cellular network 108. The communication device 104 may be configured to convert the user instructions received via the user interface 402 into the related control commands that are understandable by a control panel of the UV 106.

In a preferred embodiment of the present invention, the UV 106 may have limited set of control commands and the commands may be predefined. Therefore, the communication device 104 may use the list of the predefined commands to select a most relevant control command for the UV 106 based on the instructions received from the user via the user interface 402 of the communication device 104. The communication device 104 may transmit the selected predefined commands to the UV 106 via the cellular network 108 and the UV 106 may respond to the predefined commands as configured.

At step 608, the communication device 104 receives data from the UV 106 via the cellular network. The received data may include, but is not limited to, surveillance data received from the image sensor 202 installed on the UV 106 that are capable of capturing 3D high definition videos. In an embodiment of the present invention, the communication between the communication device 104 and the UV 106 may be in real time. The received data may further include UV's status or monitoring data, UV's navigation data, etc. Based on the data received from the UV 106, the user 102 of the UV 106 may determine further steps for controlling operations of the UV 106. The user 102 may view live video from the cameras installed on the UV 106 to determine a path for the UV 106.

In a preferred embodiment of the present invention, the UV 106 is remotely controlled via the communication device 104 under UV's remote-operation mode, wherein the UV 106 and the communication device 104 are connected via a cellular network and the UV 106 remotely receives operation commands from the communication device 104. In addition, the UV 106 is configured to operate under the autonomous mode. The user 102 of the communication device 104 may use the UV status information to determine whether the UV 106 is operating under the remote-operation mode or under the autonomous mode. Under the autonomous mode the UV 106 is configured to self identify its operating route based on the data retrieved by its image sensor 202 and GPS 204. Further, the autonomous mode of the UV 106 is configured to automatically override the remote-operation mode of the UV 106 under certain predefined conditions.

Further, the UV 106 may be configured to navigate autonomously (under autonomous mode) using GPS information, 3D image sensing capacities, and artificial intelligence. The UV 106 may use an integrated sensor for collecting information, such as images and 3D data. In addition, the UV 106 may be installed with certain special task sensors for measuring temperature and humidity and may also be equipped with other components like speakers, microphone, etc.

Further, the UV 106 may be equipped with a state of art artificial cognitive system (not shown) for special purposes like take-off, operating, and landing in different type of terrains. The artificial cognitive system (e.g., the Artificial Intelligence Module 210 as shown in FIG. 2 of the present invention) may also be used to avoid collisions with other UVs and with other operating or moving objects. Additionally, the UV 106 may be designed to operate in a safe protected mode. In the safe protected mode, the UV 106 may use an auto pilot function that may be designed to prevent the UV 106 from user mistakes or abuse. For example, if the user 102 tries to crash the UV 106 into a mountain or into another object, the UV 106 may take over the control and may operate only in its predetermined safe operating zone. Further, under the safe protected mode, the UV 106 may keep a safe distance from animals, people, and from other moving or stationary objects.

In an exemplary embodiment of the present invention, the UV 106 may pre-store information corresponding to safe operating zones or may download or generate the information in real time. In a preferred embodiment of the present invention, the UV 106 may be configured to use various sensors installed on the UV 106 (such as GPS, Laser, or Image sensors) to determine safe operating zones by analyzing its surroundings in real time after every preset time interval. Further, based on information retrieved via the GPS 204, the UV 106 may be restricted to operate in certain predefined restricted and limited geographical regions.

For example, three types of restricted and limited geographical regions may be predefined for the operation of the UV 106. Such regions may include, but are not restricted to, a no-network zone, restricted height zone, and restricted zone. Under no network zones, the user 102 may not be able to control the UV 106. Therefore, prior to entering such type of zone the user 102 must approve and indicate destination location for the UV 106. The UV 106 may then reach to the destination location autonomously by operating under autonomous mode, which may use the image sensor 202, GPS 204, and the artificial intelligence module 210 for determining operating path.

Further, during the autonomous mode, the UV 106 may scan its surroundings for identifying moving and non moving obstacles in it way to avoid collision. Based on the scanned surroundings, the UV 106 may determine its speed and direction and may self define a safe operating zone every 10 msec. In a preferred embodiment of the present invention, the UV 106 may be restricted to operate in safe operating zones only despite the fact that the UV 106 is operating under the autonomous mode or the remote-operation mode.

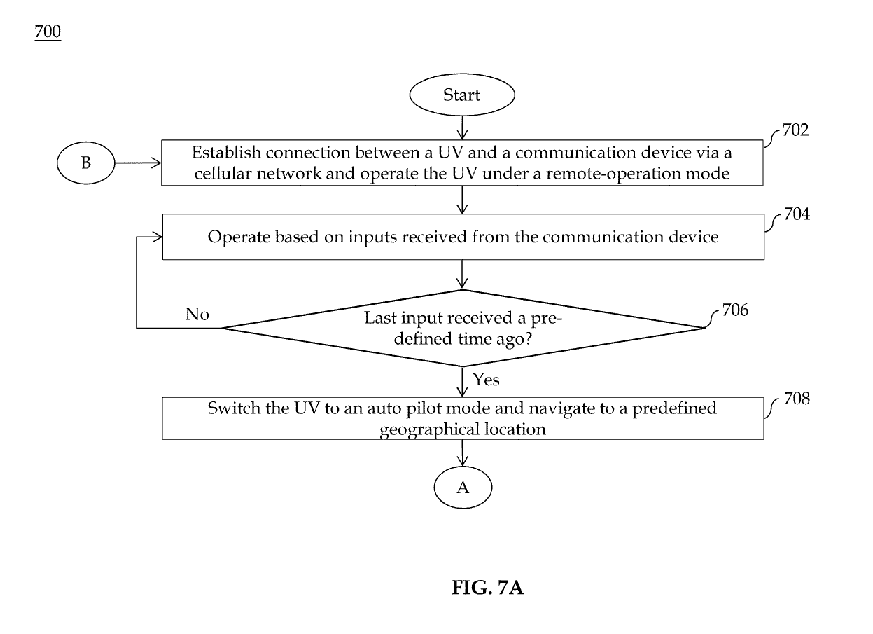

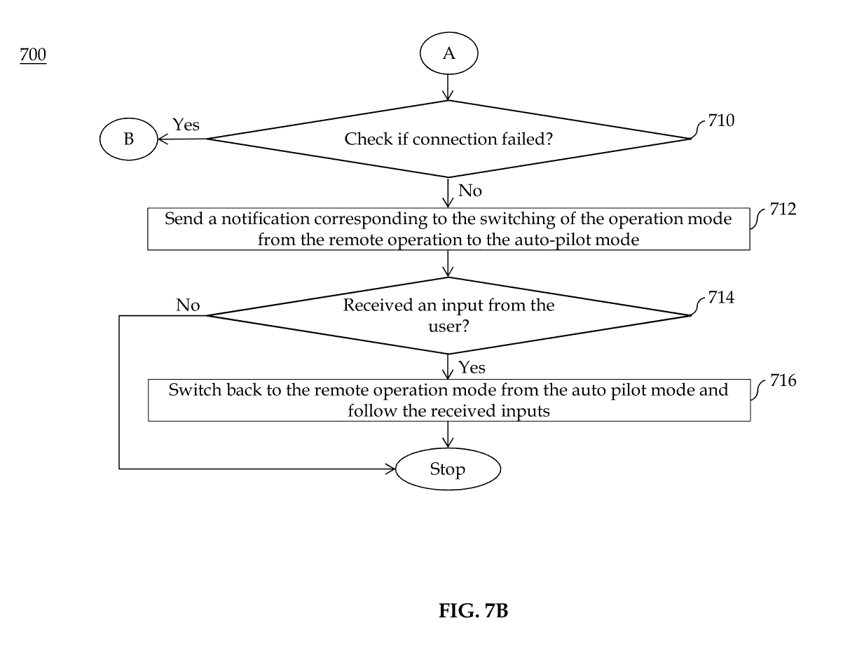

FIGS. 7A and 7B depict a flowchart of a method 700 for autonomously managing operating modes of an Unmanned vehicle (e.g., the UV 106), according to an exemplary embodiment of the present invention. At step 702, a communication device, such as the communication device 104 (as shown in FIG. 1 of the present invention), establishes a communication link with the UV 106 via a network, such as the cellular network 108. In a preferred embodiment of the present invention, the communication device 104 establishes a communication link with the UV 106 via the cellular network 108 or the Internet. Further, the communication link with the UV 106 with the communication device 104 may be used by the user 102 of the communication device 104 to remotely control the operations of the UV 106.

The communication device 104 may be used to receive inputs from the user 102. The user inputs may correspond to control commands for controlling the UV 106 from a different geographical location. In an embodiment of the present invention, the communication device 104 may be a cellular phone, a joystick, a keyboard, or similar controller. In a preferred embodiment of the present invention, the communication device 104 is a Smartphone and the user 102 of the Smartphone provides inputs via touch-screen of the Smartphone.

At step 704, the UV 106 is operated based on the inputs received from the user 102, wherein the communication device 104 transmits the control commands received from the user 102 to the UV 106 via the cellular network using the transceiver 406 compatible with the cellular network. The UV 106 may also be equipped with a similar transceiver 206 for communicating with the communication device 104 via the cellular network 108. Further, the communication device 104 may be configured to convert the user instructions received via the user interface 402 into the related control commands that are understandable by the control panel (not shown) of the UV 106. In this manner, the user 102 may control operations of the UV 106 from remote places.

At step 706, the UV 106 may determine whether the last instruction received from the user 102 was more than a pre-defined time ago or not. If the UV 106 determines that it has been more than a pre-defined time interval since any instruction from the user 102 was received, then the method 700 may proceed to step 708. Otherwise, if the UV 106 determines that the user 102 is frequently providing operation instructions then the UV 106 may continue the operation as defined in the step 704.

At step 708, the UV 106 takes over its operation controls and switches to an autonomous mode. This step is necessary to ensure safety of the UV 106 in case of a communication failure where the user 102 is not able to communicate with the UV 106 or in case where the user 102 is medically or physically not able to control the UV 106. In a preferred embodiment of the present invention, the UV 106 may be pre-configured to return to a pre-defined geographical location in case the user 102 abandons the UV 106.

Referring to FIG. 7B, at step 710, after switching to the autonomous mode, the UV 106 may check the communication link with the user 102. If the UV 106 determines that the communication link with the UV 106 has failed then the method 700 may loop back to the step 702 (of FIG. 7A) to re-establish the communication link with the user 102. Otherwise, if the UV 106 determines that the communication link with the user is still functional then the method 700 may proceed to step 712, where the UV 106 sends a notification corresponding to the switching of the operation mode from the remote operation to autonomous mode to the user 102.

At step 714, the UV 106 checks if any instruction is received from the user 102. If any instruction is received from the user 102 after notifying the user 102 (at step 712) corresponding to the switching of the operating mode, then the method 700 may proceed to step 716, where the UV 106 switches its operating operation back to the remote operation mode in which the user 102 has the control on the operation of the UV 106. Otherwise, if the UV 106 determines that no instruction is received from the user 102 then the method 700 ends therein by letting the UV 106 operate to the predefined geographical location (as defined in step 708).

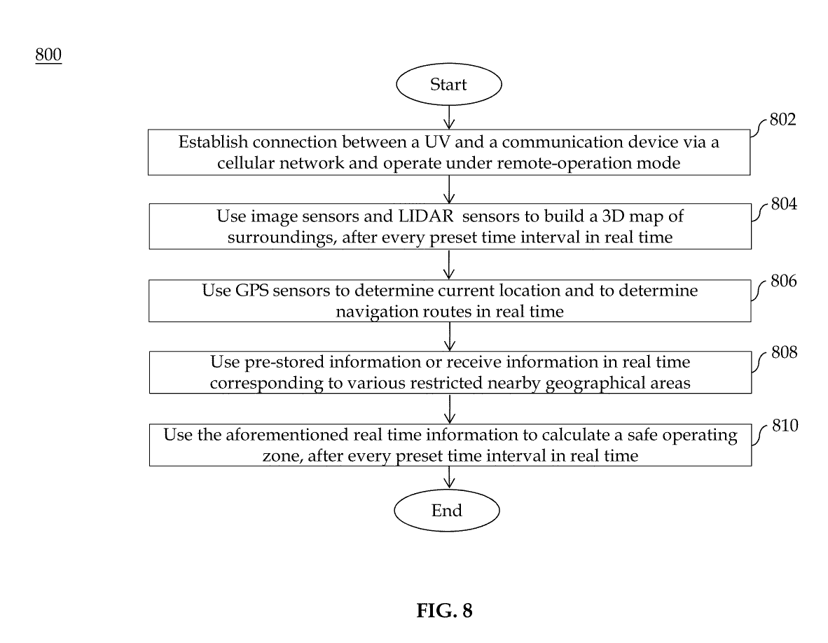

FIG. 8 depicts a flowchart of a method 800 for calculating a safe operating zone path for an Unmanned vehicle (e.g., the UV 106), according to an exemplary embodiment of the present invention. At step 802, a communication device, such as the communication device 104 (as shown in FIG. 1 of the present invention), establishes a communication link with the UV 106 via a network, such as the network 108. In a preferred embodiment of the present invention, the communication device 104 establishes a communication link with the UV 106 via the cellular network 108 or the Internet. Further, the communication link with the UV 106 with the communication device 104 may be used by the user 102 of the communication device 104 to remotely control the operations of the UV 106. The communication device 104 may be used to receive inputs from the user 102. The user inputs may correspond to control commands for controlling the UV 106 from different geographical locations. Thereafter, the UV 106 is operated based on the inputs received from the user 102, wherein the communication device 104 transmits the control commands received from the user 102 to the UV 106 via the cellular network 108 using the transceiver 406 compatible with the cellular network 108.

At step 804, the UV 106 uses its plurality of image sensors and LIDAR (Light Detection and Ranging) image sensors to build a 3D map of its surroundings and nearby objects (moving or stationary) in real time. This process is repeated after every pre-determined time interval. The UV 106 may use state of the art software programs to convert the images and distances measured via the image sensors and the LIDAR sensors into a 3 dimensional map showing all the moving as well as stationary objects along with their precise longitudes, latitudes and altitudes.

Further, at step 806, the UV 106 uses its GPS sensors to determine its current geographical location and the route it is following from its starting point. The UV 106 may also use its GPS sensors to determine route to a predefined location, which is the destination at which the UV 106 is configured to reach in case the UV 106 is abandoned by the user 102 or if the communication fails between the UV 106 and the user 102. Additionally, the UV 106 may use the GPS sensors to automatically determine its path when operating under the autonomous mode.

At step 808, the UV 106 uses pre-stored information in its memory corresponding to various restricted geographical areas where the UV 106 is either restricted from operating or is either restricted to operate only at pre-defined altitudes. In an embodiment of the present invention, the UV 106 may also be configured to receive such information in real time via the cellular network 108. The user 102 who is remotely operating the UV 106 or an organization that is sponsoring the UV 106 may update the UV 106 in real time corresponding to various restricted operating zones. The UV 106 may thus exclude such operating zones while operating under the autonomous mode.

At step 810, the UV 106 may use all of the information collected in the real time or the information retrieved from its memory to determine a safe operating zone. Such determination may be performed after every predefined time interval. In an embodiment of the present invention, the predefined time interval may be of order of milliseconds or microseconds. For example, based on the data retrieved from its image sensors, the UV 106 will be able to draw a 3D map of its surroundings that may help the UV 106 to determine places where collision is possible and hence should keep a safe distance from such places. Thereafter, the UV 106 may use the GPS sensors to determine its current location and distance from various nearby restricted operating zones. The UV 106 may therefore exclude the restricted operating zones based on the determination of the safe operating zone. This enables the UV 106 to create the safe operating zone map in real time after every pre-determined time interval.

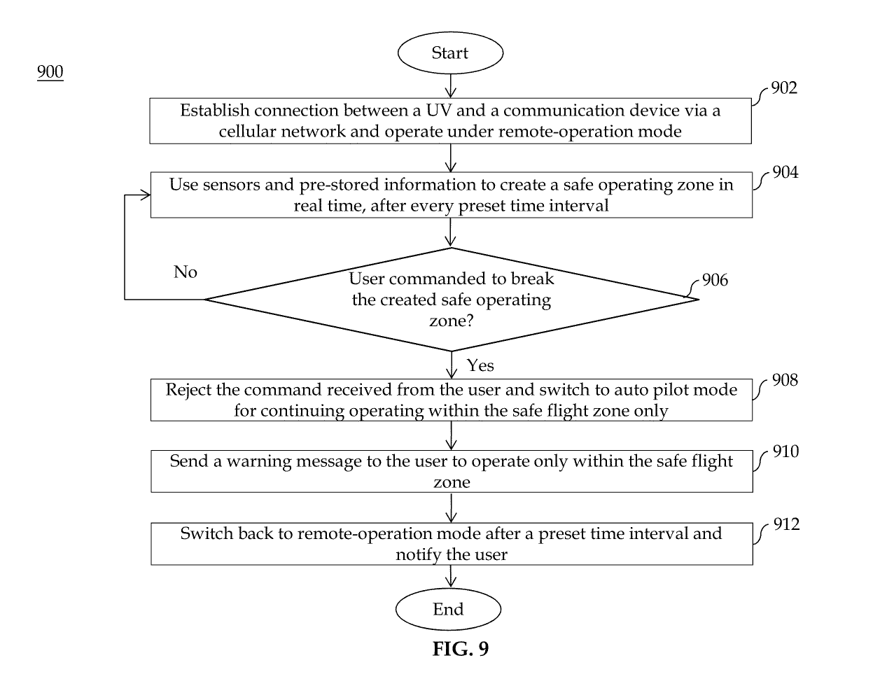

FIG. 9 depicts a flowchart of a method 900 for implementing a safe operating zone only path for an Unmanned vehicle (e.g., the UV 106), according to an exemplary embodiment of the present invention. At step 902, a communication device, such as the communication device 104 (as shown in FIG. 1 of the present invention), establishes a communication link with the UV 106 via a network, such as the network 108. In a preferred embodiment of the present invention, the communication device 104 establishes a communication link with the UV 106 via a cellular network 108 or the Internet. Further, the communication link with the UV 106 with the communication device 104 may be used by the user 102 of the communication device 104 to remotely control the operations of the UV 106. Thereafter, the UV 106 is operated based on the inputs received from the user 102, wherein the communication device 104 transmits the control commands received from the user 102 to the UV 106 via the cellular network 108 using the transceiver 406 compatible with the cellular network 108.

At step 904, the UV 106 uses its various sensors and pre-stored information in its memory to create a safe operating zone in real time after every preset time interval (as defined earlier in conjunction with FIG. 8 of the present invention). At step 906, the UV 106 checks if the user 102 gave a command that may result in violation of the safe operating zone or not. If the UV 106 determined that the user 102 tried to violate the safe operating zone then the method may proceed to step 908. Otherwise, the method may loop back to step 904 where the UV 106 keeps ensuring that the user 102 s operating the UV 106 under the safe operating zone only.

At step 908, where the UV 106 determines that the user 102 is not conforming to the safe operating zone then the UV 106 rejects the commands received from the user 102 and automatically switches to its auto pilot mode, where the UV 106 is configured to operate only in the safe operating zones. This may protect the UV 106 from any kind of miss-happenings or user abuse.

At step 910, the UV 106 sends a warning message to the user 102 for notifying that the user 102 is expected to operate the UV 106 only under safe operating zones. Thereafter, at step 912, the UV 106 may continue to operate under the autonomous mode for certain time period and may switch back to the remote operation mode as soon as the UV 106 receives an acknowledgement from the user 102 corresponding to the warning. After switching back to the remote operation mode, the UV 106 may notify the user 102 to take over the controls.

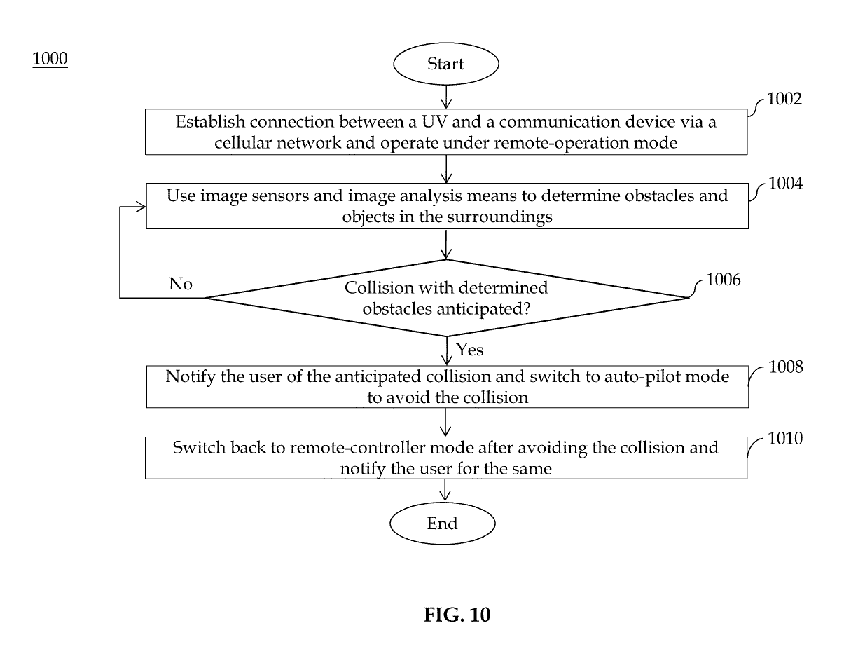

FIG. 10 depicts a flowchart of a method 1000 for automatic detection and avoidance from an anticipated collision for an Unmanned vehicle (e.g., the UV 106), according to an exemplary embodiment of the present invention. At step 1002, a communication device, such as the communication device 104 (as shown in FIG. 1 of the present invention), establishes a communication link with the UV 106 via a network, such as the network 108. In a preferred embodiment of the present invention, the communication device 104 establishes a communication link with the UV 106 via a cellular network 108 or the Internet. Further, the communication link with the UV 106 with the communication device 104 may be used by the user 102 of the communication device 104 to remotely control the operations of the UV 106. Thereafter, the UV 106 is operated based on the inputs received from the user 102, wherein the communication device 104 transmits the control commands received from the user 102 to the UV 106 via the cellular network 108 using the transceiver 406 compatible with the cellular network 108.

At step 1004, the UV 106 uses its various sensors and pre-stored information in its memory to create a safe operating zone in real time after every preset time interval (as defined earlier in conjunction with FIG. 8 of the present invention). Further, while determining the safe operating zone, the UV 106 ensures that the UV 106 maintains a safe distance from all obstacles or objects (stationary as well as moving objects). Under remote operation mode, when the user 102 is controlling the UV 106, the UV 106 may continue analyzing its surroundings via its LIDAR and image sensors to determine all the objects present in its surroundings. The UV 106 further calculates the operating pattern of the user 102 and distance of the UV 106 from the nearby objects to anticipate a collision situation.

At step 1006, if the UV 106 determines that a collision is anticipated with a nearby obstacle, then the method 1000 may proceed forward to the step 1008 where the user 102 is notified of the anticipated collision and the UV 106 automatically overtakes its operation by switching to autonomous mode to avoid collision by operating back to the safe operating zones. Otherwise, if the UV 106 does not determine any threat of collision then the method 1000 may loop back to step 1004 where the user 102 continues operating the UV 106 and the UV 106 continues anticipating potential collision situations. Thereafter, at step 1010, after avoiding the collision by following the safe operating zones, the UV 106 may notify the user 102 to take back the controls and may then switch its operating mode back to the remote operation mode as soon as the UV 106 receives acknowledgement from the user 102.

The present invention may be practiced in a plurality of manners. In one of such embodiments of the present invention, the UV 106 may be used by a security organization, such as Police force. The Police force may use the UV 106 to follow a vehicle on road. The Police force may either instruct the UV 106 to identify the vehicle and then automatically track the vehicle without a need of any remote operator and the UV 106 may transmit live streaming video of the vehicle to the related authorities. This information may also be transmitted to police vehicles on patrol for arresting or stopping the vehicle in an efficient manner.

In another embodiment of the present invention, the UV 106 may be used by private business owners such as construction organizations to track development of the construction projects. Engineers, investors, owners, partners, etc. may be facilitated by the UV 106 to remotely visit the construction site using the UV 106 to track the exact status of the construction progress. In addition, the UV 106 may be installed with microphones and speakers that may enable the engineers to communicate directly with the workers working on the site and with the ease of sitting at home, office, or hotels.

Further, the UV 106 may also be used for the purpose of delivering parcels or maps or any object that can be managed by the UV 106. The UV 106 may be a small drone, a helicopter, a quad copter, or an octacopter. The UV 106 may be configured to use image analysis systems to recognize destined persons or destined places. The UV 106 may be configured to deliver parcels to houses, or balcony of multi story offices or buildings.

In yet another embodiment of the present invention, the UV 106 may be used by travel and tourism industry for enabling tourists to visit dangerous places in real time with the comfort of sitting on a couch with a laptop or Smartphone. For example, the tourists may visit the Grand Canyon using the UV 106 from a safe distance. The UV 106 may be installed with high quality image sensors to take pictures or record videos for the tourists.

Further, the UV 106 may be configured to automatically recognize a tree or other obstacles when operating in urban areas and trying to reach its destination by going over the obstacles using its camera to recognize the obstacles and to find a way to pass over them with a safe distance. In addition, the users may be provided with an online portal from where they can login and provide their requirements to select a suitable UV 106 and a payment scheme. In an embodiment, the user may pay in advance for using the UV 106 for a limited amount of time or distance. The payment may be made using e-commerce transactions and the user may be provided with competitive payment options such as “pay as you go” payment model. Moreover, the users may also be facilitated to control the speed and direction of the UV 106 during the mission.

It should be appreciated by a person skilled in the art that while the flowcharts have been discussed and illustrated in relation to a particular sequence of events, it should be appreciated that changes, additions, and omissions to this sequence can occur without materially affecting the operation of the present invention. A number of variations and modifications of the present invention can be used. It would be possible to provide for some features of the present invention without providing others.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as a JAVA® Applet or a CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A communication device comprising:
a user interface for receiving an input from a user;
a command generator configured to generate at least one control command based on the input, wherein the at least one control command is associated with at least one predefined control function of an Unmanned Aerial Vehicle (UAV); and
a transceiver configured to transmit, in real time, at least one cellular communication signal to the UAV, wherein the at least one cellular communication signal comprises the at least one control command.

2. The communication device of claim 1, wherein the communication device is one of a smart phone, tablet, laptop, or PDA.

3. The communication device of claim 1, wherein the communication device is communicatively coupled with the UAV via at least one of the Internet, one or more cellular networks, and one or more radio links.

4. The communication device of claim 1, wherein the input is received from the user via at least one of a touch interface, a tangible button, a gesture, a microphone, a camera, and an accelerometer.

5. The communication device of claim 4, wherein the user interface is further configured to display the received data from the UAV.

6. The communication device of claim 4, wherein the received data from the UAV comprises at least one of video surveillance data, UAV status data, and UAV navigation data.

7. The communication device of claim 4, wherein the UAV status data comprises information corresponding to whether UAV is flying under auto-pilot mode or under remote-operation mode.

8. An Unmanned Aerial Vehicle (UAV), comprising:
an image sensor;
a Global Positioning System (GPS) tracking unit;
a transceiver for receiving control commands from a mobile terminal and for transmitting surveillance and navigational data captured via the image sensor and the GPS tracking unit to the mobile terminal in real time, wherein the transceiver and the mobile terminal are connected via a cellular network;
a flight control module for controlling the UAV based on the control commands received from the mobile terminal; and
an artificial intelligence module for overriding the received control commands under predefined conditions with predefined control commands.

9. The UAV of claim 8 further comprising a temperature module, a humidity module, a pressure module, a Laser module, and an Inertial Measurement Unit (IMU).

10. The UAV of claim 8, wherein the artificial intelligence module is further configured to scan surroundings of the UAV via the image sensor to determine a safe flying zone every preset time interval.

11. The UAV of claim 8, wherein the predefined conditions are at least one of an expected collision, an expected entrance into a predefined restricted zone, an expected entrance into a predefined restricted height zone, and an expected violation of the safe flying zone.

12. The UAV of claim 11, wherein the artificial intelligence module enables the UAV to keep a predefined distance from human beings, animals, and moving objects for avoiding collision.

13. The UAV of claim 11, wherein the artificial intelligence module restricts the UAV from entering the predefined restricted zone.

14. The UAV of claim 11, wherein the artificial intelligence module enables the UAV to navigate at predetermined altitudes only within a predefined restricted height zone.

15. The UAV of claim 11, wherein the artificial intelligence module restricts the UAV to fly within the safe flying zone.

16. The UAV of claim 8, wherein the UAV is controlled by the mobile terminal to deliver a package to a destination.

17. The UAV of claim 16, wherein the UAV is configured to communicate to an entity at the destination, wherein the UAV is further configured to receive voice signature of the entity confirming delivery of the package.

18. A system for controlling unmanned aircraft comprising:
at least one communication device having a transceiver configured for operation in a cellular communication network; and
an unmanned aerial vehicle (UAV) including a transceiver configured for operation in the cellular communication network, wherein the UAV is responsive to communications from the at least one ground control communication device, including communications received via the transceiver, wherein the communications received via the transceiver comprises at least one control command.

19. The system of claim 18, wherein the at least one ground control communication device is a Smartphone.

20. The system of claim 18, wherein the control command is provided via at least one of a touch interface, a tangible button, a gesture, a microphone, a camera, and an accelerometer of the communication device.

21. A method for controlling an Unmanned Aerial Vehicle (UAV), comprising:
receiving control commands at the UAV from a mobile terminal over a cellular network; and
controlling the UAV based on the received control commands, wherein the received control commands are overridden with predefined control commands under predefined conditions.

22. The method of claim 21, further comprising transmitting surveillance information captured by the UAV based on the control commands.

23. The method of claim 21, further comprising scanning surroundings of the UAV to determine a safe flying zone every preset time interval.

24. The method of claim 21, further comprising maintaining a predefined distance between the UAV and at least one of a human being, an animal, and a moving object for avoiding collision.

25. The method of claim 21, wherein the predefined conditions are at least one of an expected collision, an expected entrance into a predefined restricted zone, an expected entrance into a predefined restricted height zone, and an expected violation of the safe flying zone.

26. The method of claim 25, further comprising restricting the UAV from entering the predefined restricted zone.

27. The method of claim 25, further comprising navigating the UAV at predetermined altitudes only within the predefined restricted height zone.

28. The method of claim 25, further comprising restricting the UAV to fly within the safe flying zone.

29. The method of claim 21, wherein the UAV is controlled by the mobile terminal to deliver a package to a destination.

30. The method of claim 29, further comprising communicating with an entity at the destination, and receives voice signature of the entity confirming delivery of the package.
